(19) United States
(12) Patent Application Publication
(10) Pub. No.: US 2010/0051301 A1
(43) Pub. Date: Mar. 4, 2010

(54) Use of Composite Diamond Coating On Motor Grader Wear Inserts

(75) Inventors: Dustin Thomas Staade, Dubuque, IA (US); Lawrence William Bergquist, Dubuque, IA (US)

Correspondence Address: BAKER & DANIELS LLP, 300 NORTH MERIDIAN STREET, SUITE 2700, INDIANAPOLIS, IN, 46204, US

(73) Assignee: DEERE & COMPANY, Moline, IL (US)

(21) Appl. No.: 12/045,549

(22) Filed: Mar. 10, 2008

(51) Int. Cl. A01B 35/30; A01B 35/20; A01B 23/04

(52) U.S. Cl. 172/684.5; 172/747; 172/776

(57) ABSTRACT

A motor grader is disclosed having a coated wear insert.

### BACKGROUND

1. Field of the Invention

The present disclosure relates to a motor grader having a wear insert. More particularly, the present disclosure relates to a motor grader having a coated wear insert.

2. Description of the Related Art

Motor graders may be provided with a blade for pushing, shearing, carrying, and leveling soil and other material. The blade is configured to move in various directions relative to a chassis of the motor grader. For example, the blade may translate side to side, rotate side to side, and tilt forward and backward, relative to the chassis. As the blade moves relative to the chassis, a moving component coupled to the blade may interact with another component. Over time, as these components interact, their mating surfaces may wear against one another. This wear may be intensified when debris, such as soil and rocks, seeps between the mating surfaces.

### SUMMARY

According to an embodiment of the present disclosure, a motor grader is provided that includes a chassis, a ground engaging mechanism, an operator station, a blade, a frame, and a blade insert. The ground engaging mechanism is configured to support and propel the chassis, and the operator station is supported by the chassis. The blade has a rail and is configured to translate side to side relative to the chassis. The frame is coupled to the chassis and supports the blade. The blade insert is coupled to the frame. The blade insert is adjacent to the rail of the blade, which moves relative to the blade insert during the side to side translation of the blade. At least one of the rail and the blade insert includes a composite diamond coating.

According to another embodiment of the present disclosure, a motor grader is provided that includes a chassis, a ground engaging mechanism, an operator station, a blade, a circle gear, a draft frame, and a circle insert. The ground engaging mechanism is configured to support and propel the chassis, and the operator station is supported by the chassis. The blade is configured to rotate side to side relative to the chassis. The circle gear is coupled to the blade, and the draft frame is coupled to the chassis. The circle insert is coupled to the draft frame. The circle insert is adjacent to the circle gear, which moves relative to the circle insert during the side to side rotation of the blade. At least one of the circle gear and the circle insert includes a composite diamond coating.

According to yet another embodiment of the present disclosure, a motor grader is provided that includes a chassis, a ground engaging mechanism, an operator station, and a moldboard assembly. The ground engaging mechanism is configured to support and propel the chassis, and the operator station is supported by the chassis. The moldboard assembly includes a blade, an actuator, a first mating surface, and a second mating surface having a composite diamond coating. The actuator is configured to move the blade relative to the chassis, and the first mating surface interacts with the second mating surface during this movement of the blade.

### BRIEF DESCRIPTION OF THE DRAWINGS

The above-mentioned and other features of the present disclosure will become more apparent and the present disclosure itself will be better understood by reference to the following description of embodiments of the present disclosure taken in conjunction with the accompanying drawings, wherein:

FIG. 1 is a side view of a motor grader having a moldboard assembly of the present disclosure;

FIG. 2 is a perspective view of the moldboard assembly of FIG. 1;

FIG. 3 is another perspective view of a portion of the moldboard assembly of FIG. 2 showing a blade insert;

FIG. 4 is a side view of a portion of the moldboard assembly of FIG. 3 showing the blade insert;

FIG. 5 is another side view of a portion of the moldboard assembly of FIG. 4 showing the blade insert;

FIG. 6 is a perspective view of the moldboard assembly of FIG. 5 showing the blade insert;

FIG. 7 is a perspective view of a portion of the moldboard assembly of FIG. 2 showing a circle insert;

FIG. 8 is an enlarged view of a portion of the moldboard assembly of FIG. 7 showing the circle insert;

FIG. 9 is a chart showing experimental results of blade insert wear for various blade inserts; and

FIG. 10 is a chart showing experimental results of rail wear for various blade inserts.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

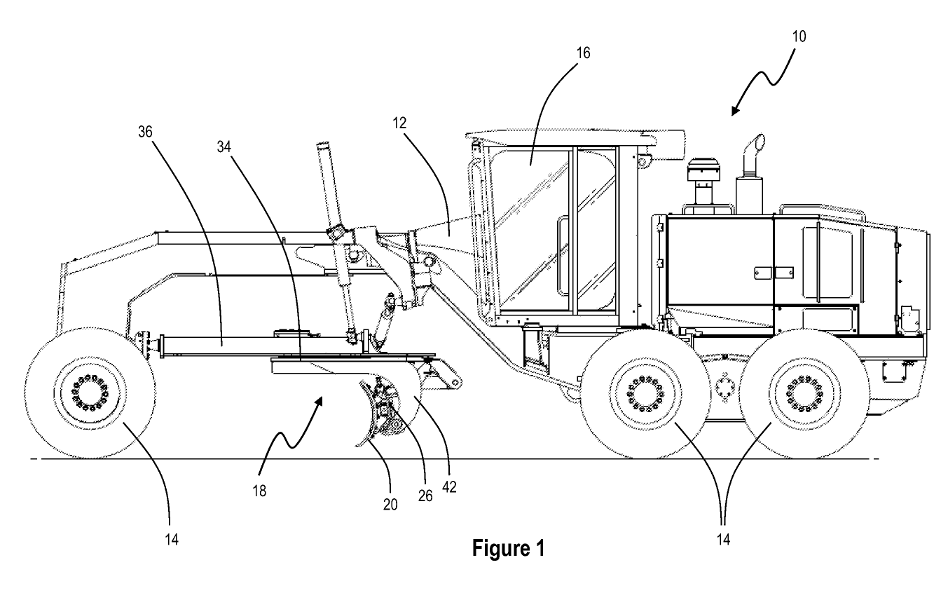

Referring to FIG. 1, a vehicle in the form of motor grader 10 is provided. Although the vehicle is illustrated and described herein as motor grader 10, the vehicle may include any other type of vehicle including, for example, a bulldozer or an excavator. Motor grader 10 includes chassis 12 and ground engaging mechanism 14. Ground engaging mechanism 14 may include any device capable of supporting and/or propelling chassis 12. For example, as illustrated in FIG. 1, ground engaging mechanism 14 may include wheels. Motor grader 10 further includes operator station 16 supported by chassis 12 for an operator of motor grader 10.

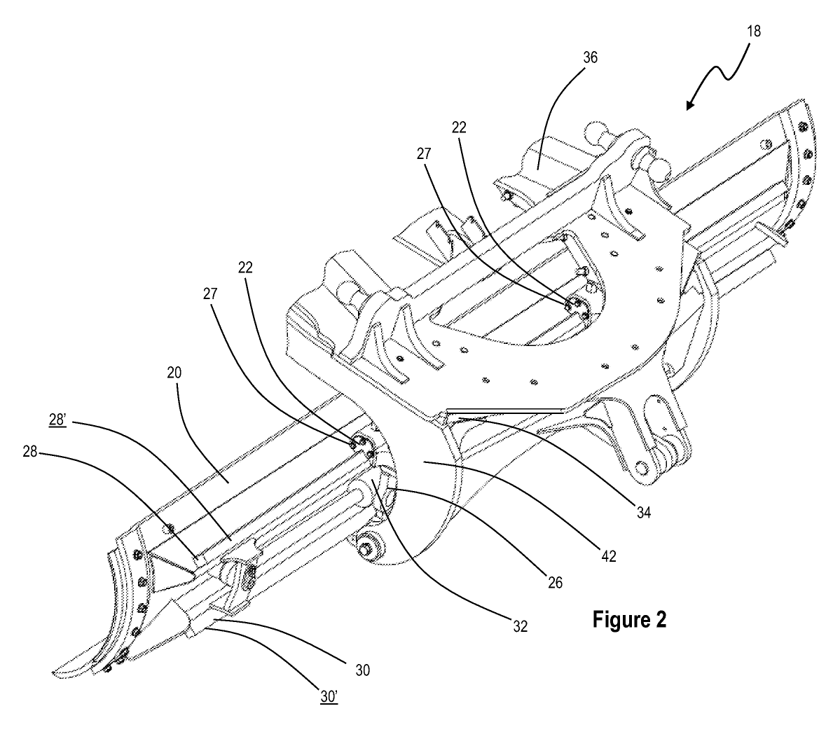

Referring to FIGS. 1-2, motor grader 10 further includes moldboard assembly 18. Moldboard assembly 18 includes blade 20 for pushing, spreading, and leveling soil and other material. Blade 20 may be concave in shape when viewed from the front of motor grader 10. Moldboard assembly 18 may also include various components for moving blade 20 relative to chassis 12.

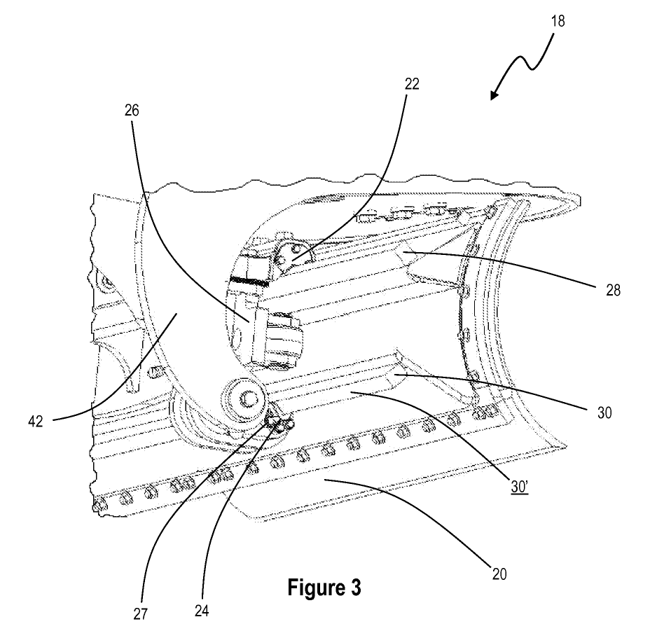

As shown in FIG. 3, to facilitate translation of blade 20 side to side relative to chassis 12, moldboard assembly 18 includes blade insert 24, coupled to tilt frame 26 using bolts 27. A similar blade insert (not shown) is positioned behind end cap 22. Adjacent to blade insert 24, moldboard assembly 18 further includes rail 30 coupled to blade 20. Adjacent to the upper blade insert positioned behind end cap 22, moldboard assembly 18 further includes rail 28 coupled to blade 20. Rails 28, 30, may be fastened to blade 20 or formed integrally with blade 20. Blade insert 24 may be made of any metal or metallic alloy, such as aluminum bronze, and rails 28, 30, may be made of any metal or metallic alloy, such as steel. Blade insert 24 and rails 28, 30, may be shaped such that blade 20 is permitted to translate side to side but prevented from moving in other directions. For example, rails 28, 30, may have a square cross-section and blade insert 24 may be V-shaped. Rails 28, 30 may also have triangular, diamond, rectangular, circular and other polygon shaped cross-sections.

As shown in FIG. 2, translation of blade 20 right and left relative to tilt frame 26 may be accomplished using, for example, hydraulic cylinder 32 between blade 20 and tilt frame 26. As hydraulic cylinder 32 extends and retracts, rail 28 of blade 20 slides across the adjacent upper blade insert, and rail 30 of blade 20 slides across adjacent blade insert 24. More specifically, mating surface 28′ of rail 28 slides across an adjacent mating surface of the upper blade insert, and mating surface 30′ of rail 30 slides across adjacent mating surface 24′ of blade insert 24. The upper blade insert, blade insert 24, and/or rails 28, 30, may include additional components to enhance the side to side translation of blade 20. For example, mating surface 24′ of blade insert 24 may include a strip of material attached to blade insert 24.

As shown in FIGS. 1, 2, 7, and 8, to facilitate rotation of blade 20 side to side relative to chassis 12, moldboard assembly 18 may further include circle gear 34 and draft frame 36. Blade 20 is coupled to circle gear 34 for rotation therewith. More specifically, blade 20 is coupled to tilt frame 26, and tilt frame 26 is in turn coupled to circle frame 42 of circle gear 34. Circle gear 34 is rotatably coupled to draft frame 36, and draft frame 36 is in turn coupled to chassis 12. Draft frame 36 may include any number of circle inserts 38 spaced adjacent to and radially about circle gear 34, permitting circle gear 34 to rotate relative to draft frame 36 but preventing circle gear 34 from moving in other directions. Circle inserts 38 may be fastened to draft frame 36 with bolts 39, and circle inserts 38 may be made of any metal or metallic alloy, such as bronze. Rotation of circle gear 34 relative to draft frame 36 may be accomplished, for example, by driving a pinion gear (not shown) that interacts with teeth 40 of circle gear 34 to rotate circle gear 34 and blade 20 coupled thereto. As circle gear 34 rotates, it slides across adjacent circle insert 38. More specifically, mating surface 34′ of circle gear 34 slides across adjacent mating surface 38′ of circle insert 38.

As shown in FIGS. 1-2, to tilt blade 20 forward and backward relative to chassis 12, circle frame 42 may be integrally formed with circle gear 34, and may be pivotally connected to tilt frame 26. Blade 20 may be tilted forward and backward relative to chassis 12 by, for example, extending and retracting a hydraulic cylinder (not shown) positioned between circle frame 42 and tilt frame 26.

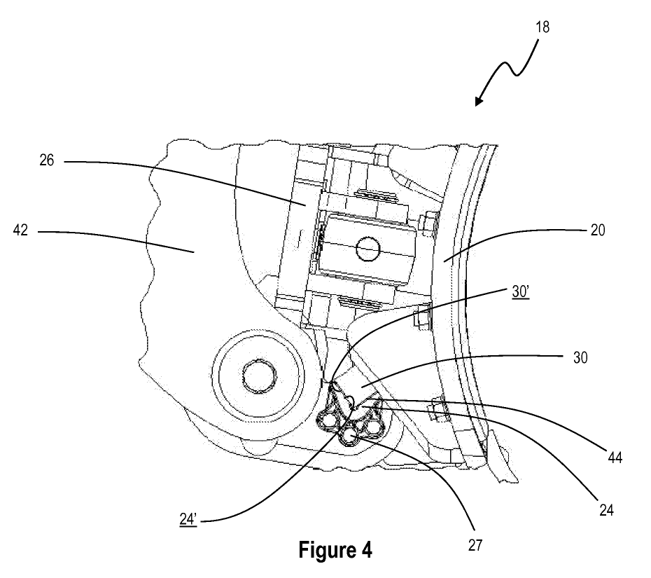

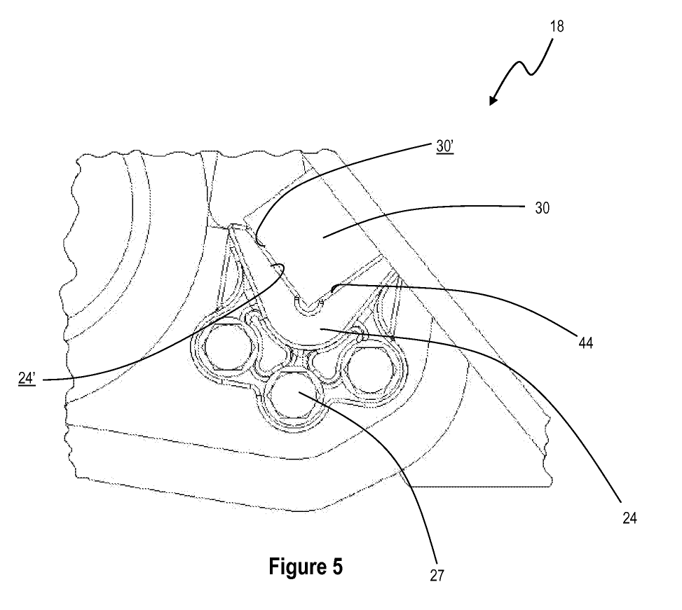

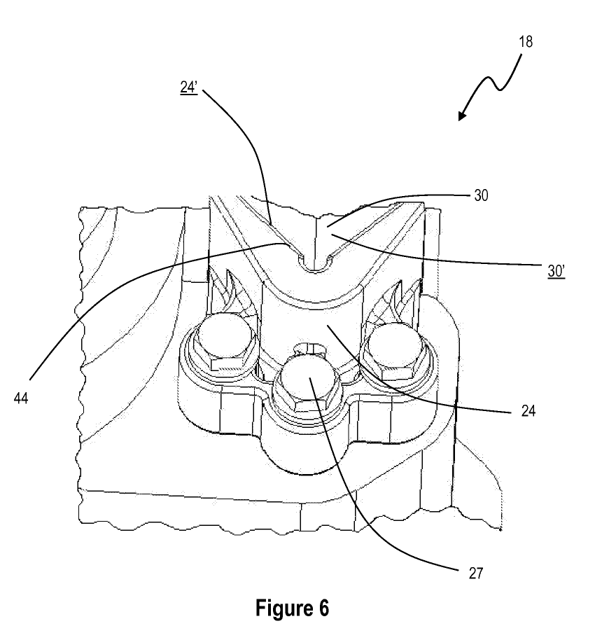

Referring generally to FIGS. 4-8, motor grader 10, and specifically moldboard assembly 18, may include surface coating 44. In particular, mating surfaces of moldboard assembly 18 may include surface coating 44. Surface coating 44 may be in the form of a composite diamond coating, such as Composite Diamond Coating™ currently available from Surface Technology, Inc. of Trenton, N.J. The hardness of composite diamond coatings is approximately 1,200 Vickers. This hardness is achieved by dispersing ultra-fine diamond particles, which alone have a hardness of 10,000 Vickers, throughout electroless nickel, which alone has a hardness of only 950 Vickers. Specifically, composite diamond coatings may include between approximately 65.8% and 72% electroless nickel by volume and between approximately 25% and 30% diamond by volume. Composite diamond coatings may also include phosphorus in amounts less than approximately 5% by volume. The diamond particles dispersed throughout the electroless nickel may have an average particle size of 2 microns (CDC-2), 8 microns (CDC-8), or any other suitable size. For example, if a rough composite diamond coating is desired, the diamond particles dispersed throughout the electroless nickel may have an average particle size greater than 8 microns.

Surface coating 44 may have a thickness between approximately 0.0002 inches (0.2 mil) and 0.025 inches (25 mil). An exemplary thickness of surface coating 44 may be between approximately 0.001 inches (1 mil) and 0.010 inches (10 mil), and more specifically, between approximately 0.002 inches (2 mil) and 0.004 inches (4 mil). The thickness of surface coating 44 may be essentially even across a mating surface of moldboard assembly 18. For example, the thickness of surface coating 44 across a mating surface of moldboard assembly 18 may vary by less than 0.0001 inches (0.1 mil).

The finish of surface coating 44 may vary, depending on the desired finish of the mating surface of moldboard assembly 18. A rough surface coating 44 may be accomplished by applying a composite diamond coating having large diamond particles, as mentioned above. A smooth surface coating 44 may be accomplished by applying a composite diamond coating having small diamond particles and/or by polishing the underlying mating surface before applying surface coating 44.

According to an exemplary embodiment of the present disclosure, illustrated in FIGS. 3-6, surface coating 44 may be applied to the upper blade insert, blade insert 24, and/or rails 28, 30. In particular, surface coating 44 may be applied to at least a mating surface of the upper blade insert, mating surface 24′ of blade insert 24, mating surface 28′ of rail 28, and/or mating surface 30′ of rail 30.

An experiment was conducted to examine the effects of coating blade insert 24 with surface coating 44. Rail 30 was left uncoated. A first part of the experiment examined the effect of coating blade insert 24 with surface coating 44 on blade insert 24 itself. Five blade inserts (A-E), described in Table 1 below, were tested.

TABLE 1

| Blade | | | |
|---|---|---|---|
| Insert | Geometry | Material | Coating |
| A | Standard Duty | UNS C95400 Aluminum Bronze | None |
| B | Heavy Duty | UNS C95400 Aluminum Bronze | None |
| C | Heavy Duty | UNS C95520 Aluminum Bronze | None |
| D | Heavy Duty | UNS C95400 Aluminum Bronze | CDC-2 (1 mil) |
| E | Heavy Duty | UNS C95400 Aluminum Bronze | CDC-2 (2 mil) |

Referring to Table 1 above, three uncoated blade inserts (A-C) were first tested. The uncoated blade inserts (A-C) had various geometries (“Standard Duty” geometry and “Heavy Duty” geometry). The “Heavy Duty” blade inserts were longer and wider than the “Standard Duty” blade insert, so the mating surfaces of the “Heavy Duty” blade inserts had more surface area than the mating surface of the “Standard Duty” blade insert. The uncoated blade inserts (A-C) were also made of different materials (UNS C95400 Aluminum Bronze and UNS C95520 Aluminum Bronze).

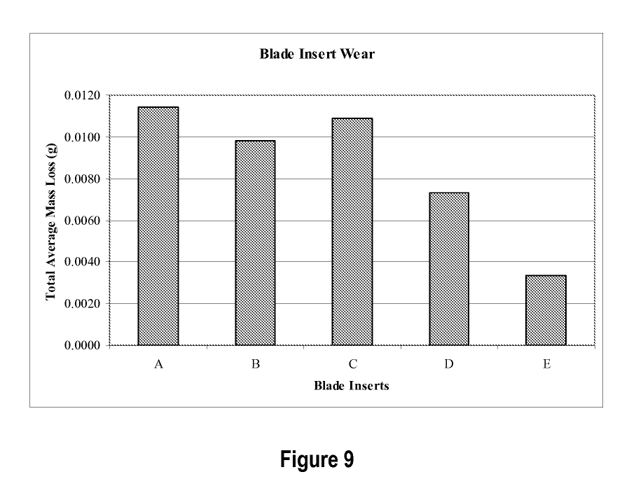

Referring to FIG. 9, of the three uncoated blade inserts (A-C), blade insert B incurred the least amount of wear. Blade insert B was then coated with 0.001 inches (1 mil) of CDC-2 (D) and 0.002 inches (2 mil) of CDC-2 (E). Compared to blade insert B, blade insert D incurred approximately 25% less wear, and blade insert E incurred approximately 65% less wear. Therefore, applying surface coating 44 to blade insert 24 reduces the wear incurred by blade insert 24. Also, increasing the thickness of surface coating 44 on blade insert 24 further reduces the wear incurred by blade insert 24.

A second part of the experiment examined the effect on rail 30 when surface coating 44 was applied to blade insert 24. Again, rail 30 was left uncoated. Rail 30 was tested against three blade inserts, described in Table 2 below, including blade inserts B and C from above.

TABLE 2

| Blade | | | |
|---|---|---|---|
| Insert | Geometry | Material | Coating |
| B | Heavy Duty | UNS C95400 Aluminum Bronze | None |
| C | Heavy Duty | UNS C95520 Aluminum Bronze | None |
| F | Heavy Duty | UNS C95520 Aluminum Bronze | CDC-2 (2 mil) |

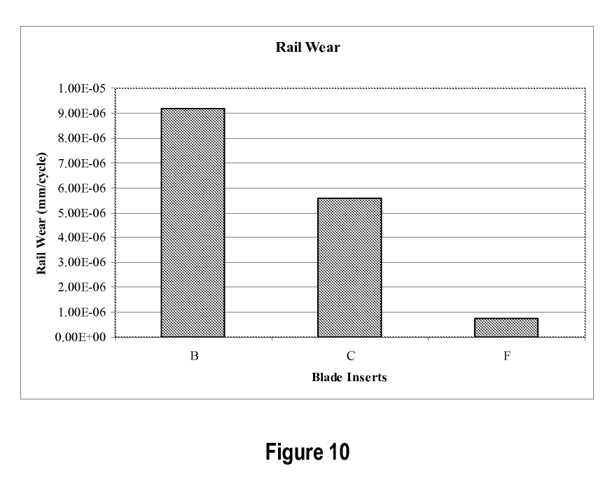

Referring back to FIG. 9, blade insert B incurred less wear than blade insert C. However, as shown in FIG. 10, the rail incurred more wear from blade insert B than blade insert C. In other words, as the blade insert incurred less wear, the rail suffered more wear, and vice versa. Therefore, one would expect that coating the surface of blade insert C would impose even more wear on the rail. However, as shown in FIG. 10, the opposite result occurred. Coating blade insert C with 0.002 inches (2 mil) of CDC-2 (F) actually imposed over 85% less wear on the rail.

In summary, the presence of surface coating 44 on blade insert 24 reduced the wear of blade insert 24. Also, though unexpected, the presence of surface coating 44 on blade insert 24 reduced the wear of rail 30. Although rail 30 interacted with coated blade insert 24 having increased hardness, surface coating 44 on blade insert 24 reduced the wear imposed on rail 30, even without having to apply surface coating 44 to rail 30 itself.

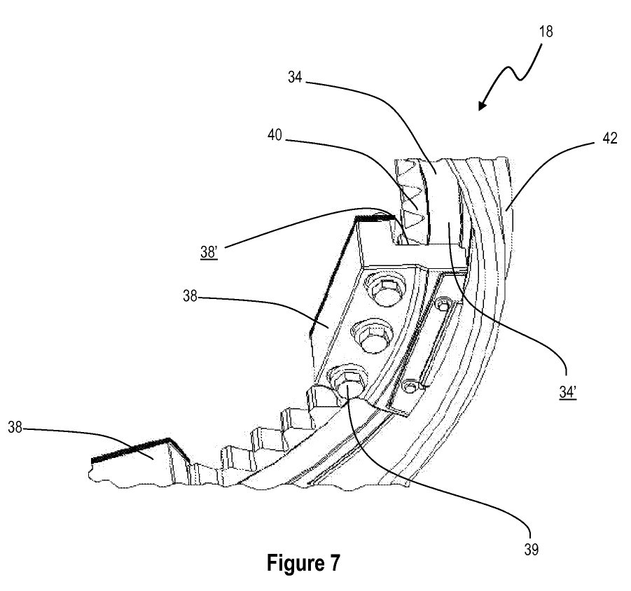

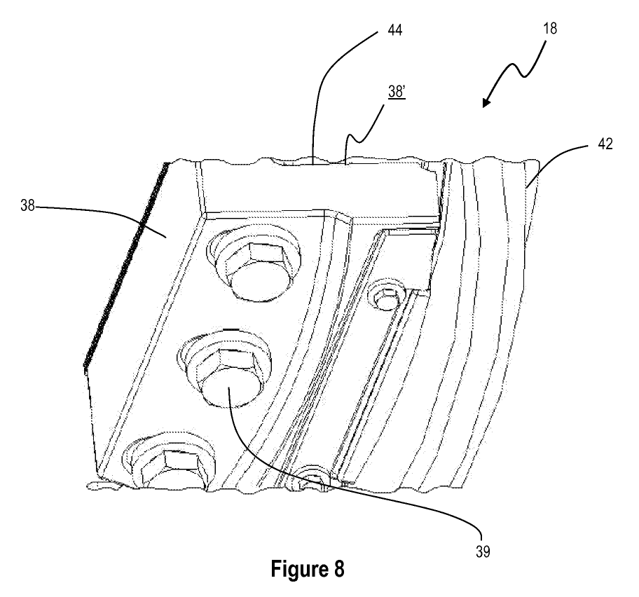

According to another exemplary embodiment of the present disclosure, illustrated in FIGS. 7-8, surface coating 44 may be applied to circle gear 34 and/or circle insert 38. In particular, surface coating 44 may be applied to at least mating surface 34′ of circle gear 34 and/or mating surface 38′ of circle insert 38. Based on the previous experiment, surface coating 44 applied to circle insert 38 may not only reduce the wear rate of circle insert 38, but may also reduce the wear rate of circle gear 34.

While this invention has been described as having preferred designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A motor grader including:
a chassis;
a ground engaging mechanism configured to support and propel the chassis;
an operator station supported by the chassis;
a blade having a rail, the blade being configured to translate side to side relative to the chassis;
a frame coupled to the chassis and supporting the blade; and
a blade insert coupled to the frame, the blade insert being adjacent to the rail of the blade and the rail moving relative to the blade insert during the side to side translation of the blade, and at least one of the rail and the blade insert including a composite diamond coating.

2. The motor grader of claim 1, wherein the composite diamond coating includes:
between approximately 65.8% and 72% nickel by volume;
between approximately 25% and 30% diamond by volume; and
less than approximately 5% phosphorous by volume.

3. The motor grader of claim 1, wherein a thickness of the composite diamond coating is between approximately 0.001 inches and 0.010 inches.

4. The motor grader of claim 1, wherein the composite diamond coating includes diamond particles having an average size of approximately 2 microns.

5. The motor grader of claim 1, wherein the composite diamond coating essentially covers a mating surface of the blade insert that is adjacent to the rail.

6. The motor grader of claim 1, wherein the blade insert includes at least one of bronze and any other alloy.

7. The motor grader of claim 1, wherein the rail is made of steel.

8. The motor grader of claim 1, wherein the frame supporting the blade is configured to tilt forward and backward relative to the chassis.

9. A motor grader including:
a chassis;
a ground engaging mechanism configured to support and propel the chassis;
an operator station supported by the chassis;
a blade configured to rotate side to side relative to the chassis;
a circle gear coupled to the blade;
a draft frame coupled to the chassis; and
a circle insert coupled to the draft frame, the circle insert being adjacent to the circle gear and the circle gear moving relative to the circle insert during the side to side rotation of the blade, and at least one of the circle gear and the circle insert including a composite diamond coating.

10. The motor grader of claim 9, wherein the composite diamond coating includes:
between approximately 65.8% and 72% nickel by volume;
between approximately 25% and 30% diamond by volume; and
less than approximately 5% phosphorous by volume.

11. The motor grader of claim 9, wherein a thickness of the composite diamond coating is between approximately 0.001 inches and 0.010 inches.

12. The motor grader of claim 9, wherein the composite diamond coating includes diamond particles having an average size of approximately 2 microns.

13. The motor grader of claim 9, wherein the composite diamond coating essentially covers a mating surface of the circle insert that is adjacent to the circle gear.

14. The motor grader of claim 9, wherein the circle insert includes at least one of bronze and any other alloy.

15. The motor grader of claim 9, further including a tilt frame that couples the circle gear to the blade.

16. A motor grader including:
a chassis;
a ground engaging mechanism configured to support and propel the chassis;
an operator station supported by the chassis; and
a moldboard assembly including:
a blade;
an actuator configured to move the blade relative to the chassis;
a first mating surface; and
a second mating surface having a composite diamond coating, the first mating surface interacting with the second mating surface during movement of the blade.

17. The motor grader of claim 16, wherein the composite diamond coating includes:
between approximately 65.8% and 72% nickel by volume;
between approximately 25% and 30% diamond by volume; and
less than approximately 5% phosphorous by volume.

18. The motor grader of claim 16, wherein a thickness of the composite diamond coating is between approximately 0.001 inches and 0.010 inches.

19. The motor grader of claim 16, wherein the moldboard assembly further includes:
a rail mounted on the blade and having the first mating surface; and
a blade insert having the second mating surface.

20. The motor grader of claim 16, wherein the moldboard assembly further includes:
a circle gear supported by the chassis to rotate the blade relative to the chassis, the circle gear having the first mating surface; and
a circle insert having the second mating surface.

21. The motor grader of claim 16, wherein the first mating surface also includes the composite diamond coating.
